(19) United States
(12) Patent Application Publication
(10) Pub. No.: US 2017/0363025 A1
(43) Pub. Date: Dec. 21, 2017

(54) CONTROL APPARATUS FOR INTERNAL COMBUSTION ENGINE

(71) Applicant: TOYOTA JIDOSHA KABUSHIKI KAISHA, Toyota-shi (JP)

(72) Inventors: Masatoshi YOSHINAGA, Susono-shi (JP); Shinji SADAKANE, Susono-shi (JP); Hiroshi YOSHIMURA, Gotenba-shi (JP); Hideto WAKABAYASHI, Shizuoka-ken (JP)

(73) Assignee: TOYOTA JIDOSHA KABUSHIKI KAISHA, Toyota-shi (JP)

(21) Appl. No.: 15/626,705

(22) Filed: Jun. 19, 2017

(30) Foreign Application Priority Data
Jun. 21, 2016 (JP) 2016-122652

(51) Int. Cl. F02D 41/00; F01N 3/10; F02M 26/07; F02M 26/22; F02M 35/10; F01N 11/00

(52) U.S. Cl. CPC F02D 41/0007; F02M 35/1038; F01N 11/005; F02M 26/07; F02M 26/22; F01N 3/10

(57) ABSTRACT

In an internal combustion engine that includes: an EGR channel that connects a portion of an exhaust channel on the upstream side of a downstream-side catalyst and a portion of an intake channel on the downstream side of both of a compressor and a throttle valve; and an EGR valve configured to open and close the EGR channel, a control apparatus is programmed, where an occurrence of a blow-through air that flows from the intake channel to the exhaust channel via the EGR channel is detected, to limit a throttle downstream pressure to reduce the overheating of the downstream-side catalyst.

### CROSS-REFERENCE TO RELATED APPLICATION

This application is based on and claims the benefit of Japanese Patent Application No. 2016-122652, filed on Jun. 21, 2016, which is incorporated by reference herein in its entirety.

### BACKGROUND

### Technical Field

The present disclosure relates to a control apparatus for an internal combustion engine, and more particularly to a control apparatus that is suitable for controlling an internal combustion engine that includes an EGR channel that connects a part of an exhaust channel on the upstream side of an exhaust gas purification catalyst and a part of an intake channel on the downstream side of both of a compressor and a throttle valve.

### Background Art

For example, JP 2010-138839A discloses an internal combustion engine that includes a compressor for supercharging intake air. This internal combustion engine includes an EGR channel and an EGR valve. The EGR channel connects a part of an exhaust channel on the upstream side of an exhaust gas purification catalyst and a part of an intake channel on the downstream side of both of a compressor and a throttle valve. The EGR valve opens and closes the EGR channel.

In addition to JP 2010-138839A, JP 2014-005778A is a patent document which may be related to the present disclosure.

### SUMMARY OF THE INVENTION

In a supercharged internal combustion engine that includes the EGR channel having the configuration disclosed in JP 2010-138839A, if the EGR valve goes wrong and cannot be closed at the time of the intake pressure being higher than the exhaust pressure with supercharging, a blow-through air (blow-though fresh air) occurs in the following manner. That is, a phenomenon in which an air is flown from the intake channel to the exhaust channel through the EGR channel occurs. If this kind of air flow occurs, a part of the fresh air flows into the exhaust channel without passing through a combustion chamber. As a result of this, the air-fuel ratio of the mixture gas in a cylinder changes to the richer side. If an unburned gas is discharged from the cylinder due to this change of the air-fuel ratio, the discharged unburned gas joins a fresh air that has flown in the exhaust channel through the EGR channel, and an unburned fuel of the unburned gas reacts with the fresh air on the exhaust gas purification catalyst. As a result of this, the temperature of the exhaust gas purification catalyst rises. Therefore, there is a concern that the exhaust gas purification catalyst may become overheated.

The present disclosure has been made to address the problem described above, and an object of the present disclosure is to provide a control apparatus for an internal combustion engine that can reduce the overheating of an exhaust gas purification catalyst due to a blow-through air that flows from an intake channel to an exhaust channel via an EGR channel even if a closing failure of an EGR valve occurs.

A control apparatus for controlling an internal combustion engine according to the present disclosure is configured to control an internal combustion engine that includes: a compressor arranged in an intake channel and configured to supercharge intake air; a throttle valve arranged in a portion of the intake channel on a downstream side of the compressor and configured to open and close the intake channel; an exhaust gas purification catalyst configured to purify exhaust gas that flows through an exhaust channel; an EGR channel that connects a portion of the exhaust channel on an upstream side of the exhaust gas purification catalyst and a portion of the intake channel on a downstream side of the throttle valve; and an EGR valve arranged in the EGR channel and configured to open and close the EGR channel. The control apparatus includes a blow-through air detecting section programmed to detect an occurrence of a blow-through air that flows from the intake channel to the exhaust channel via the EGR channel; and an intake air pressure limiting section programmed to limit an throttle downstream pressure that is an intake air pressure at the portion of the intake channel on the downstream side of the throttle valve to reduce overheating of the exhaust gas purification catalyst where an occurrence of the blow-through air is detected.

The control apparatus may further include: a blow-through air flow rate obtaining section programmed to obtain a flow rate of the blow-through air; an inflow air flow rate obtaining section programmed to obtain a flow rate of inflow air to the intake channel; and a catalyst temperature estimation section programmed to calculate, as a final temperature estimation value of the exhaust gas purification catalyst at a time of an occurrence of the blow-through air being detected, a sum of a base catalyst temperature estimation value based on an operating condition of the internal combustion engine and a catalyst temperature increase amount based on the flow rate of the blow-through air and the flow rate of the inflow air. Where an occurrence of the blow-through air is detected and the final temperature estimation value is higher than an overheat determination value, the intake air pressure limiting section may limit the throttle downstream pressure such that the throttle downstream pressure becomes equal to or lower than a value corresponding to the overheat determination value.

The control apparatus may further include: a blow-through air flow rate obtaining section programmed to obtain a flow rate of the blow-through air; an inflow air flow rate obtaining section programmed to obtain a flow rate of inflow air to the intake channel; and a catalyst temperature estimation section programmed to calculate, as a final temperature estimation value of the exhaust gas purification catalyst at a time of an occurrence of the blow-through air being detected, a sum of a base catalyst temperature estimation value based on an operating condition of the internal combustion engine and a catalyst temperature increase amount based on the flow rate of the blow-through air and the flow rate of the inflow air. Where an occurrence of the blow-through air is detected and the final temperature estimation value is equal to or lower than the overheat determination value, the intake air pressure limiting section may forbid the throttle downstream pressure from being limited.

Where an occurrence of the blow-through air is detected, the intake air pressure limiting section may limit the throttle downstream pressure such that the throttle downstream pressure becomes equal to or lower than an exhaust pressure value. The exhaust pressure value may be a value of the exhaust pressure at the portion of the exhaust channel to which the EGR channel is connected, and may be at an engine load where the exhaust pressure of the portion of the exhaust channel becomes equal to the throttle downstream pressure under a current engine speed.

The exhaust pressure value may become greater when the engine speed is higher.

According to the control apparatus for an internal combustion engine of the present disclosure, the overheating of the exhaust gas purification catalyst due to a blow-through air that flows from the intake channel to the exhaust channel via the EGR channel can be reduced even if a closing failure of the EGR valve occurs.

### BRIEF DESCRIPTION OF THE DRAWINGS

FIG. 1 is a diagram for illustrating a configuration of a system according to a first embodiment of the present invention;

FIG. 2 is a graph that illustrates a relationship of an engine operating region with a throttle downstream pressure Pm and an exhaust gas pressure Pex;

FIG. 3 is a flow chart that represents an example of a routine of the processing executed by an ECU according to the first embodiment of the present invention;

FIG. 4 is a graph that illustrates a relationship between a catalyst temperature increase amount ΔTuf of a downstream-side catalyst and a blow-through air ratio at the time of occurrence of a blow-through air;

FIG. 5 is a graph for explaining an example of a calculation manner of an upper limit value Pmul′ of a target intake air pressure Pmrq used in a second embodiment of the present invention; and

FIG. 6 is a flow chart that represents an example of a routine of the processing executed by the ECU according to the second embodiment of the present invention.

### DETAILED DESCRIPTION

In the following, embodiments according to the present invention will be described with reference to the drawings. The same components in the drawings are denoted by the same reference numerals, and redundant descriptions thereof will be omitted. The embodiments described below are not intended to limit the present invention.

### First Embodiment

### [Description of Configuration of System]

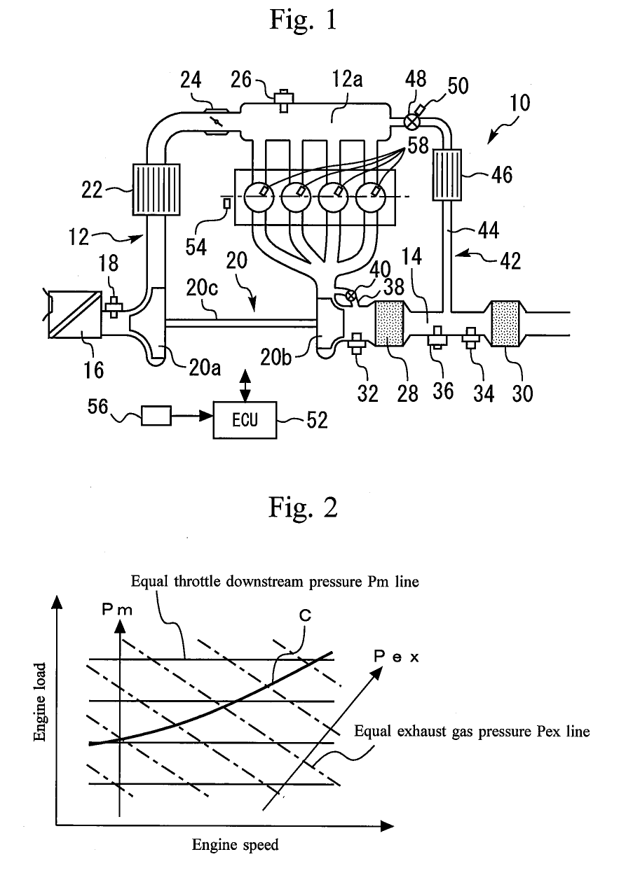

FIG. 1 is a diagram for illustrating a configuration of a system according to a first embodiment of the present invention. The system according to the present embodiment includes an internal combustion engine (a spark ignition gasoline engine, for example) 10. Each cylinder of the internal combustion engine 10 is in communication with an intake channel 12 and an exhaust channel 14.

An air cleaner 16 is attached to the intake channel 12 at a position close to an inlet of the intake channel 12. An air flow sensor 18 that outputs a signal that is responsive to the flow rate of air taken into the intake channel 12 is provided in the vicinity of, and downstream of, the air cleaner 16. A compressor 20a of a turbo-supercharger 20 is provided downstream of the air flow sensor 18. The compressor 20a is integrally coupled to a turbine 20b disposed in the exhaust channel 14 by a coupling shaft 20c.

An intercooler 22, which cools the air compressed by the compressor 20a, is provided downstream of the compressor 20a. An electronically controlled throttle valve 24 is provided downstream of the intercooler 22. An intake air pressure sensor 26 that detects an intake air pressure Pm (hereunder, referred to as a “throttle downstream pressure”) is attached to the intake channel 12 at a position on the downstream side of the throttle valve 24 (for example, at a surge tank 12a). The throttle downstream pressure Pm can be controlled with adjustment of the opening degree of the throttle valve 24.

An upstream-side catalyst 28 and a downstream-side catalyst 30 are installed in series in the exhaust channel 14 at positions on the downstream side of the turbine 20b in order to purifying exhaust gas. Each of these catalysts 28 and 30 is a three-way catalyst. Also, an upstream-side air-fuel ratio sensor 32 is attached to a part of the exhaust channel 14 located between the turbine 20b and the upstream-side catalyst 28. Further, a downstream-side air-fuel ratio sensor 34 is attached to a part of the exhaust channel 14 located between the upstream-side catalyst 28 and the downstream-side catalyst 30. These air-fuel ratio sensors 32 and 34 are used to control the air-fuel ratio to a target air-fuel ratio (in the present embodiment, basically, the stoichiometric air-fuel ratio). In addition, an exhaust gas pressure sensor 36 that detects an exhaust pressure is attached to a part of the exhaust channel 14 located between the upstream-side catalyst 28 and the downstream-side catalyst 30.

An exhaust bypass channel 38 that connects the inlet side and the outlet side of the turbine 20b to bypasses the turbine 20b is connected to the exhaust channel 14. The exhaust bypass channel 38 is provided with a waste gate valve (WGV) 40 that opens and closes the exhaust bypass channel 38. The WGV 40 is of the electrically-driven type, for example. The throttle downstream pressure Pm can also be controlled with adjustment of the opening degree of the WGV 40.

The internal combustion engine 10 shown in FIG. 1 includes an EGR device 42. The EGR device 42 includes an EGR channel 44 that connects, to each other, a part of the exhaust channel 14 on the downstream side of the upstream-side catalyst 28 and on the upstream side of the downstream-side catalyst 30 and a part of the intake channel 12 on the downstream side of both of the compressor 20a and the throttle valve 24. Viewed from the upstream side of the flow of the EGR gas fed back to the intake channel 12 through the EGR channel 44, the EGR channel 44 includes an EGR cooler 46 and an EGR valve 48 in this order. The EGR valve 48 is provided to adjust the flow rate of the EGR gas. An EGR valve opening degree sensor 50 is attached to the EGR valve 48 to detect the EGR valve opening degree.

As shown in FIG. 1, the system according to the present embodiment further includes an electronic control unit (ECU) 52. The ECU 52 includes a random access memory (RAM), a read only memory (ROM), and a central processing unit (CPU), for example. The ECU 52 receives and processes signals from various sensors provided in a vehicle on which the internal combustion engine 10 is mounted. The various sensors include not only the air flow sensor 18, the intake air pressure sensor 26, the air-fuel ratio sensors 32 and 34, the exhaust gas pressure sensor 36 and the EGR valve opening degree sensor 50 described above but also at least a crank angle sensor 54 for detecting the engine speed and an accelerator position sensor 56 that detects the amount of depression of an accelerator pedal of the vehicle (accelerator position). The ECU 52 processes the signals received from the sensors and controls operation of various actuators according to predetermined control programs. The actuators that operate under the control of the ECU 52 include not only the throttle valve 24, the WGV 40 and the EGR valve 48 described above but also at least a fuel injection valve 58 that supplies a fuel to each cylinder of the internal combustion engine 10. The fuel injection valve 58 is configured to inject the fuel directly into the cylinder, for example.

### Control According to First Embodiment

### (Engine Torque Control Used As Premise)

With the engine torque control of the system according to the present embodiment, a target torque (that is, a required torque) is calculated in accordance with the amount of depression of the accelerator pedal, and the engine torque is controlled so as to approach a calculated target torque. To be more specific, when the target torque is calculated, a target intake air amount (that is, a target value of the amount of air charged into each cylinder) that is necessary to achieve the target torque under the current target air-fuel ratio is calculated. Calculation of the actual value of the intake air amount (that is, in-cylinder charge air amount) can be performed, for example, using a known mathematical model for the intake system. In the present embodiment, the target air-fuel ratio is basically set at the stoichiometric air-fuel ratio. The ignition timing is basically controlled to an MBT (Minimum advance for Best Torque) ignition timing.

In the example of the internal combustion engine 10, the in-cylinder charge air amount can be controlled using throttle valve 24 and the WGV 40. To be more specific, in a torque region located on the lower load side, the in-cylinder charge air amount is controlled so as to approach the target intake air amount with the adjustment of the opening degree of the throttle valve 24 with the WGV 40 being open at a maximum opening degree within an opening degree control range. In a torque region located on the higher load side (that is, in a supercharging region) that needs a greater amount of the in-cylinder charge air amount than an air amount obtained when the throttle valve 24 is fully opened under the WGV 40 being open at the maximum opening degree, the throttle downstream pressure Pm is controlled with the adjustment of the opening degree of the WGV 40 such that a target intake air pressure Pmrq for achieving the target intake air amount is obtained with the throttle valve 24 being fully open. As a result, the in-cylinder charge air amount is controlled so as to be the target intake air amount in the supercharging region. In addition, the control of the WGV 40 for the engine torque control taken as a premise is not limited to the control in the manner described above (so called, normal open control). That is, the WGV 40 may be controlled with a so-called normal close control performed in such a manner that the WGV 40 is basically closed including a low-speed and low-load operating region and that the WGV 40 is opened for the protection of the internal combustion engine when the throttle downstream pressure Pm exceeds a specified pressure value.

### (Upper Limit Guard for Target Intake Air Pressure Pmrq)

The present embodiment is premised on the target intake air pressure Pmrq that is a target value of the throttle downstream pressure Pm and that is limited as needed in the following manner. That is, in view of malfunction of various component parts of the internal combustion engine 10, such as the turbo-supercharger 20 and the throttle valve 24, an upper limit value of the target intake air pressure Pmrq is determined in advance for each predetermined contents of the malfunction. If the malfunction of a component part has not occurred, an invalid value (that is, an excessively large pressure value that does not serve as the upper limit value) is inputted as the upper limit value for this component part. If, on the other hand, malfunction of a component part has occurred, an upper limit value for the contents of the malfunction that relates to the malfunction that has occurred is used. A minimum value of upper limit values for the respective contents of the malfunction is finally used as an upper limit value of the target intake air pressure Pmrq. As a result of this, with the adjustment of the opening degree of the WGV 40 or the opening degree of the throttle valve 24, the throttle downstream pressure Pm is limited so as not to exceed this upper limit value. As just described, the limiting of the throttle downstream pressure Pm is provided as a fail-safe function. In addition, in the present embodiment, the following closing failure of the EGR valve 48 is taken into consideration as one of the contents of the malfunction. Thus, as one of the upper limit values used in the present embodiment, there is an upper limit value Pmul used at the time of occurrence of the closing failure of the EGR valve 48 as described below.

### (Issue at Time of Closing Failure of EGR Valve)

FIG. 2 is a graph that illustrates a relationship of the engine operating region with the throttle downstream pressure Pm and the exhaust gas pressure Pex. The engine operating region in FIG. 2 is determined using the engine load and the engine speed. In addition, the “exhaust gas pressure Pex” referred to in each embodiment according to the present invention indicates the pressure of a gas that flows through a portion of the exhaust channel 14 at which the EGR channel 44 is connected. In the configuration shown in FIG. 1, the pressure of a gas that flows through the exhaust channel 14 at a location between the upstream-side catalyst 28 and the downstream-side catalyst 30 corresponds to the “exhaust gas pressure Pex” mentioned here.

FIG. 2 shows a general tendency of the throttle downstream pressure Pm and the exhaust gas pressure Pex. More specifically, the throttle downstream pressure Pm becomes higher when the engine load is higher, while the throttle downstream pressure Pm does not show a significant change when the engine speed changes. On the other hand, the exhaust gas pressure Pex changes not only depending the engine load but also depending the engine speed. In more detail, the exhaust gas pressure Pex becomes higher when the engine load is higher, and the exhaust gas pressure Pex also becomes higher when the engine speed is higher.

A closing failure of the EGR valve 38 may occur as a result of, for example, the EGR valve 48 being broken. In detail, the closing failure occurs when the EGR valve 48 is broken and remains open, for example. The curve C shown in FIG. 2 is obtained by joining engine operating points at each of which the throttle downstream pressure Pm is equal to the exhaust gas pressure Pex. If the closing failure of the EGR valve 48 occurs when the internal combustion engine 10 is operating in the operating region located on the higher speed and higher load side with respect to the curve C, a phenomenon in which an air (fresh air) is blown through the EGR channel 44 from the intake channel 12 to the exhaust channel 14 occurs. If this kind of blow-through air occurs when the air-fuel ratio is controlled to the stoichiometric air-fuel ratio, a part of the fresh air flows into the exhaust channel 14 without passing through the combustion chamber. As a result of this, a rich combustion is performed in the cylinder due to an air-fuel ratio richer than the stoichiometric air-fuel ratio. Due to an unburned gas discharged from the cylinder as a result, the upstream-side catalyst 28 is put into a rich gas atmosphere. Further, an unburned gas that has not been purified by the upstream-side catalyst 28 joins a fresh air that has flown into the exhaust channel 14 through the EGR channel 44 at the upstream of the downstream-side catalyst 30, and an unburned fuel of the unburned gas reacts with the fresh air on the downstream-side catalyst 30. As a result of this, the temperature of the downstream-side catalyst 30 rises. Therefore, there is a concern that the downstream-side catalyst 30 may become overheated.

### Outline of Throttle Downstream Pressure Control According to First Embodiment

In view of the above, in the present embodiment, it is determined whether or not a blow-through air via the EGR channel 44 occurs during operation of the internal combustion engine 10 under the stoichiometric air-fuel ratio. If the occurrence of the blow-through air is detected, the throttle downstream pressure Pm is limited so as to reduce the overheating of the downstream-side catalyst 30. To be more specific, if the blow-through air occurs, the throttle downstream pressure Pm becomes higher than the exhaust gas pressure Pex. Thus, an engine operating point in the operating region shown in FIG. 2 is positioned on the higher speed and higher load side with respect to the curve C. If this engine operating point is shifted to a point on the curve C or to an operating region located on the lower speed and lower load side with respect to the curve C, the blow-through air can be prevented from occurring. Accordingly, in the present embodiment, if the occurrence of the blow-through air is detected, the throttle downstream pressure Pm is limited so as to be equal to or lower than a value of the exhaust gas pressure Pex at an engine load where the throttle downstream pressure Pm becomes equal to the exhaust gas pressure Pex under the current engine speed.

### Concrete Processing According to First Embodiment

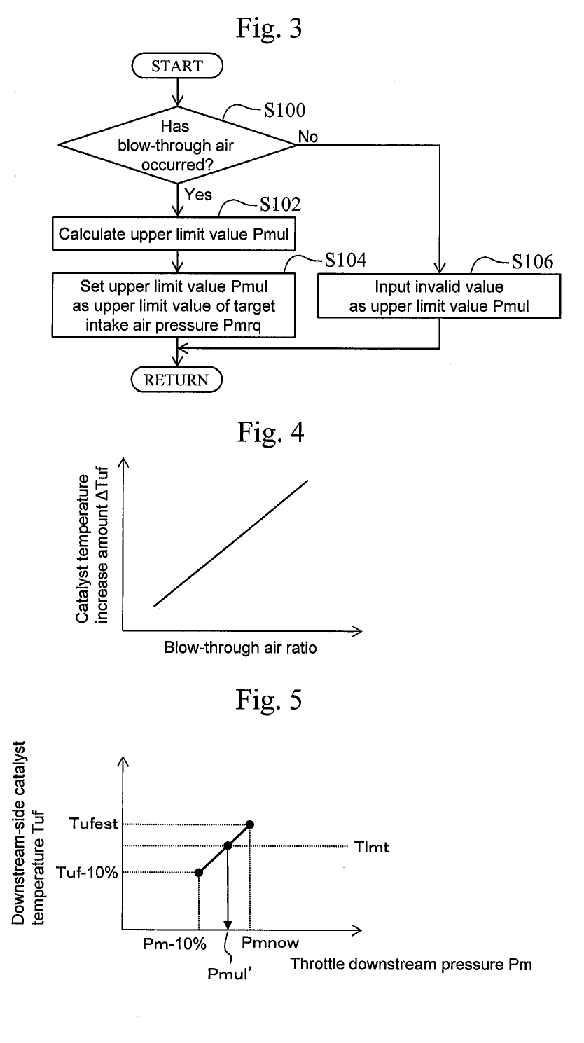

FIG. 3 is a flow chart that represents an example of a routine of the processing executed by the ECU 52 according to the first embodiment of the present invention. In addition, the routine shown in FIG. 3 is started up repeatedly for each predetermined control period during the stoichiometric air-fuel ratio operation of the internal combustion engine 10.

In the routine shown in FIG. 3, first, the ECU 52 determines whether or not an air blown through the EGR channel 44 from the intake channel 12 to the exhaust channel 14 has occurred (step S100). Whether or not the blow-through air has occurred can be determined as follows on the basis of the EGR valve opening degree, the throttle downstream pressure Pm and the exhaust gas pressure Pex, for example. That is, when the ECU 52 detects, using the EGR valve opening degree sensor 50, that the EGR valve 48 is open even though a command to close the EGR valve 48 is present, it can be determined that the closing failure of the EGR valve 38 has occurred. Further, whether or not the throttle downstream pressure Pm is higher than the exhaust gas pressure Pex is determined using both of the detection values of the intake air pressure sensor 26 and the exhaust gas pressure sensor 36. Since both the throttle downstream pressure Pm and the exhaust gas pressure Pex are pulsating, this determination can be performed, for example, based on whether or not the mean value of detection values of the throttle downstream pressure Pm during a predetermined period of time is higher than the mean value of detection values of the exhaust gas pressure Pex during the predetermined period of time. If the ECU 40 determines, in this kind of manner, that the closing failure of the EGR valve 48 has occurred and the throttle downstream pressure Pm is higher than the exhaust gas pressure Pex, it can be determined that the blow-through air has occurred. In addition, the exhaust gas pressure Pex may be estimated in a known estimation manner instead of the detection with the exhaust gas pressure sensor 36. Moreover, the occurrence of the blow-through air may be detected, for example, in the following manner instead of the manner described above. That is, an oxygen concentration sensor may be installed in the EGR channel 44, and the ECU 52 may determine that, if the detection value of the oxygen concentration becomes greater than a value of the oxygen concentration of the gas that flows through the EGR channel 44 when the blow-through air has not occurred, the blow-through air has occurred.

After the ECU 52 determines in step S100 that the blow-through air has occurred, the ECU 52 calculates the upper limit value Pmul of the throttle downstream pressure Pm (step S102). The upper limit value Pmul used when the closing failure of the EGR valve 48 has occurred is a value of the exhaust gas pressure Pex at an engine load where the throttle downstream pressure Pm becomes equal to the exhaust gas pressure Pex, and the magnitude thereof varies depending on the engine speed. More specifically, as represented in FIG. 2, the exhaust gas pressure Pex not only changes in accordance with the engine load but also becomes higher when the engine speed is higher. Accordingly, the ECU 52 stores a map (not shown in the drawings) that defines the upper limit value Pmul so as to be greater when the engine speed is higher. In step S102, the upper limit value Pmul according to the current engine speed is obtained from this kind of map. In addition, the upper limit value Pmul is not limited to just the value of the exhaust gas pressure Pm at the engine load at which the throttle downstream pressure Pm becomes equal to the exhaust gas pressure Pex, and may be a value that is smaller than the aforementioned value of the exhaust gas pressure Pex by a predetermined margin.

Next, the ECU 52 executes the processing to set, as the upper limit value of the target intake air pressure Pmrq, the upper limit value Pmul calculated in step S102 (step S104). If, on the other hand, the ECU 52 determines is step S100 that the blow-through air has not occurred, the ECU 52 inputs an invalid value as the upper limit value Pmul (step S106). As a result of this, under a condition in which the blow-through air has not occurred, the target intake air pressure Pmrq can be prevented from being limited due to the upper limit value Pmul.

According to the processing of the routine shown in FIG. 3 described so far, if the blow-through air via the EGR channel 44 has occurred, the upper limit value Pmul is set as the upper limit value of the target intake air pressure Pmrq. As a result of this, the throttle downstream pressure Pm is limited so as not to exceed the upper limit value Pmul with adjustment of the opening degree of the WGV 40 or the throttle valve 24 for controlling the throttle downstream pressure Pm. Thus, since it becomes hard for the throttle downstream pressure Pm to be higher than the exhaust gas pressure Pex, the occurrence of the blow-through air can be reduced. Therefore, when the closing failure of the EGR valve 48 has occurred, the downstream-side catalyst 30 can be prevented from being overheated due to the blow-through air.

In the first embodiment described so far, the downstream-side catalyst 30 corresponds to the “exhaust gas purification catalyst” according to the present invention, and the ECU 52 that executes the processing according to the flow chart shown in FIG. 3 corresponds to the “blow-through air detecting section” and the “intake air pressure limiting section” according to the present invention.

### Second Embodiment

Next, a second embodiment of the present invention will be described with reference to FIGS. 4 to 6. In the following description, it is assumed that the configuration shown in FIG. 1 is used as an example of the configuration of the system according to the second embodiment.

### Control According to Second Embodiment

### Outline of Throttle Downstream Pressure Control According to Second Embodiment

FIG. 4 is a graph that illustrates a relationship between a catalyst temperature increase amount ΔTuf of the downstream-side catalyst 30 and a blow-through air ratio at the time of occurrence of the blow-through air. The blow-through air ratio mentioned here is an index value concerning the blow-through air (in detail, blow-through fresh air) via the EGR channel 44, and corresponds to the ratio of the flow rate of the blow-through air to the flow rate of inflow air into the intake channel 12. In order to distinguish this flow rate of the inflow air from the amount of air charged in the cylinder, the flow rate of the inflow air is herein also referred to as a “total intake air flow rate”. In addition, the flow rate of the blow-through air mentioned here corresponds to the flow rate of the air (fresh air) that has been blown through the EGR channel 44.

The catalyst temperature increase amount ΔTuf of the downstream-side catalyst 30 due to the occurrence of the blow-through air becomes greater when the flow rate of the blow-through air is greater. However, the catalyst temperature increase amount ΔTuf changes depending on the total intake air flow rate even if the flow rate of the blow-through air does not change. If the blow-through air ratio defined as described above is used, the relationship of the catalyst temperature increase amount ΔTuf with respect to the flow rate of the blow-through air and the total intake air flow rate can be organized so as to be expressed with a first-order proportional relationship as shown in FIG. 4. According to the relationship shown in FIG. 4, the catalyst temperature increase amount ΔTuf becomes greater when the blow-through air ratio is higher.

FIG. 5 is a graph for explaining an example of the calculation manner of an upper limit value Pmul′ of the target intake air pressure Pmrq used in the second embodiment of the present invention. In the present embodiment, the catalyst temperature increase amount ΔTuf of the downstream-side catalyst 30 is calculated from the blow-through air ratio according to the relationship shown in FIG. 4 described above. By adding this catalyst temperature increase amount ΔTuf to a base catalyst temperature estimation value Tufbase of the downstream-side catalyst 30, calculation of a catalyst temperature estimation value Tufest is performed with taking the influence of the blow-through air into consideration. The temperature Tlmt shown in FIG. 5 corresponds to an overheat determination value that is set as a value lower by a predetermined margin than a heatproof limit temperature inherent in the downstream-side catalyst 30. In addition, the base catalyst temperature estimation value Tufbase can be obtained during operation of the internal combustion engine 10 in a manner such that, for example, a relationship between the operating condition of the internal combustion engine 10 (for example, the engine speed, the throttle downstream pressure Pm and the spark timing) and the base catalyst temperature estimation value Tufbase is determined in advance and stored, as a map, in the ECU 52.

In the present embodiment, a throttle downstream pressure value Pmul′ corresponding to the overheat determination value Tlmt is used as an upper limit value of the target intake air pressure Pmrq to be used at the time of the occurrence of the blow-through air. To be more specific, if the catalyst temperature estimation value Tufest is higher than the overheat determination value Tlmt as in the example shown in FIG. 5, the throttle downstream pressure Pm is limited so as not to exceed the upper limit value Pmul′ by using the upper limit value Pmul′ as the upper limit value of the target intake air pressure Pmrq.

The upper limit value Pmul′ can be calculated in the following manner, for example. That is, according to the calculation manner of the base catalyst temperature estimation value Tufbase described above, by using, as an input value, a throttle downstream pressure value Pm-10% that is smaller by a predetermined ratio (herein, 10%, for example) than the current throttle downstream pressure value Pmnow, a catalyst temperature estimation value Tuf-10% corresponding to the throttle downstream pressure value Pm-10% can be calculated. The predetermined ratio is a value that is determined in advance to determine a throttle downstream pressure value within a range in which the blow-through air does not occur. If the throttle downstream pressure values Pmnow and Pm-10%, the catalyst temperature estimation values Tufest and Tuf-10%, and the overheat determination value Tlmt are grasped as just described, the upper limit value Pmul′ that is a throttle downstream pressure value corresponding to the overheat determination value Tlmt can be calculated based on these values.

### Concrete Processing According to Second Embodiment

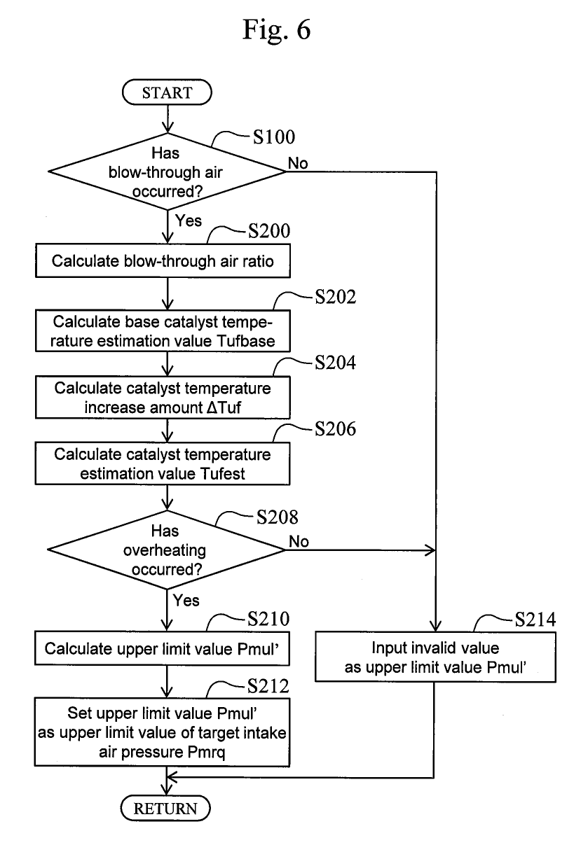

FIG. 6 is a flow chart that represents an example of a routine of the processing executed by the ECU 52 according to the second embodiment of the present invention. The processing of step S100 in the routine shown in FIG. 6 is as described in the first embodiment. In the routine shown in FIG. 6, after determining in step S100 that the blow-through air has occurred, the ECU 52 calculates the blow-through air ratio of the air (step S200).

As described above, it is required for the calculation of the blow-through air ratio to obtain the flow rate of the blow-through air and the total intake air flow rate. The total intake air flow rate can be obtained using the air flow sensor 18, for example. The flow rate of the blow-through air can be estimated, for example, in a known manner based on the EGR valve opening degree detected by the EGR valve opening degree sensor 50, the throttle downstream pressure Pm detected by the intake air pressure sensor 26, and the exhaust gas pressure Pex detected by the exhaust gas pressure sensor 36. In addition, instead of the manner described above, the flow rate of the blow-through air can also be obtained in the following manner, for example. That is, the oxygen concentration of the gas that flows through the EGR channel 44 becomes higher when the flow rate of the blow-through air is greater. Accordingly, for example, an oxygen concentration sensor may be installed in the EGR channel 44 and the flow rate of the blow-through air may be estimated on the basis of the magnitude of a difference between the detection value of the oxygen concentration and a value of the oxygen concentration in the aforementioned gas obtained when the blow-through air does not occur. Alternatively, for example, a flow rate sensor may be additionally installed in the EGR channel 44 and the flow rate of the blow-through air may be estimated on the basis of the detection value of this flow rate sensor.

Next, the ECU 52 calculates the base catalyst temperature estimation value Tufbase according to the current operating condition of the internal combustion engine 10 (that is, a temperature estimation value of the downstream-side catalyst 30 calculated without taking the influence of the blow-through air into consideration) (step S202). The base catalyst temperature estimation value Tufbase can be calculated in the manner described above, for example.

Next, the ECU 52 calculates the catalyst temperature increase amount ΔTuf (step S204). In order to calculate the catalyst temperature increase amount ΔTuf, the ECU 52 stores a map (not shown in the drawings) that defines a relationship between the catalyst temperature increase amount ΔTuf and the blow-through air ratio with the characteristics as shown in FIG. 4. In this step S204, the catalyst temperature increase amount ΔTuf corresponding to the blow-through air ratio obtained in step S200 is calculated with reference to this kind of map.

Next, the ECU 52 calculates the catalyst temperature estimation value Tufest (step S206). In detail, the catalyst temperature estimation value Tufest is calculated by adding the catalyst temperature increase amount ΔTuf that is calculated in step S204 to the base catalyst temperature estimation value Tufbase that is calculated in step S202. That is, the catalyst temperature estimation value Tufest is a temperature estimation value of the downstream-side catalyst 30 that is calculated with taking into consideration a temperature increase due to the influence of the blow-through air.

Next, the ECU 52 determines whether or not the downstream-side catalyst 30 has been overheated (step S208). Whether or not the overheating has occurred can be determined on the basis of whether or not the catalyst temperature estimation value Tufest calculated in step S206 is higher than the above described overheat determination value Tlmt with taking into consideration the heatproof limit of the downstream-side catalyst 30.

If the determination result of step S208 is positive, that is, if it can be judged that a condition where the overheating occurs is met, the ECU 52 calculates the upper limit value Pmul′ of the throttle downstream pressure Pm (step S210). The upper limit value Pmul′ can be calculated in the manner described above on the basis of, for example, the throttle downstream pressure values Pmnow and Pm-10%, the catalyst temperature estimation values Tufest and Tuf-10%, and the overheat determination value Tlmt.

Next, the ECU 52 executes the processing to set, as the upper limit value of the target intake air pressure Pmrq, the upper limit value Pmul′ calculated in step S210 (step S212). In addition, if the ECU 52 determines in step S100 that the blow-through air has not occurred, or if it determines in step S208 that the overheating has not occurred, the ECU 52 inputs an invalid value to the upper limit value Pmul′ (step S214) In other words, according to the processing of step S214, if the overheating of the downstream-side catalyst 30 has not occurred although the blow-through air has occurred, the ECU 52 forbids the limiting of the throttle downstream pressure Pm based on the upper limit value Pmul′.

According to the processing of the routine shown in FIG. 6 described so far, if a condition where the overheating of the downstream-side catalyst 30 occurs is met when the blow-through air via the EGR channel 44 occurs, the upper limit value Pmul′ is set as the upper limit value of the, target intake air pressure Pmrq. As a result of this, with the adjustment of the opening degree of the WGV 40 or the opening degree of the throttle valve 24 for controlling the throttle downstream pressure Pm, the throttle downstream pressure Pm is limited so as not to exceed the upper limit value Pmul′. Thus, when the closing failure of the EGR valve 48 has occurred, the overheating of the downstream-side catalyst 30 due to the blow-through air can be reduced while an increase of the throttle downstream pressure Pm to the upper limit in a range of the throttle downstream pressure Pm that can reduce the overheating of the downstream-side catalyst 30 is allowed (that is, while the blow-through air is allowed within a range of the blow-through air that can reduce the overheating). As just described, according to the control of the present embodiment, the throttle downstream pressure Pm can be prevented from being excessively decreased for reducing the overheating, as compared to the control according to the first embodiment. Consequently, countermeasures against the overheating of the downstream-side catalyst 30 can be performed at the time of the occurrence of the closing failure of the EGR valve 48 while the deterioration of the drivability of the internal combustion engine 10 can be reduced to the minimum.

In the second embodiment described so far, the ECU 52 that executes the processing according to the flow chart shown in FIG. 6 corresponds to the “blow-through air detecting section”, the “intake air pressure limiting section”, the “blow-through air flow rate obtaining section”, the “inflow air flow rate obtaining section”, and the “catalyst temperature estimation section” according to the present, invention. In addition, the catalyst temperature estimation value Tufest corresponds to the “final temperature estimation value” according to the present invention.

In the first and second embodiments described so far, the EGR channel 44 that is connected to the exhaust channel 14 at a location between the upstream-side catalyst 28 and the downstream-side catalyst 30 is exemplified in FIG. 1. However, the connecting location of the EGR channel according to the present invention is not limited to the aforementioned location, and may be, for example, a location of the exhaust channel 14 on the upstream side of the upstream-side catalyst 28. Even for an internal combustion engine that includes this kind of EGR channel, there is a possibility that, if the blow-through air via the EGR channel has occurred, an air (fresh air) via the EGR channel and an unburned gas from the cylinders may join with each other at a location on the upstream side of the upstream-side catalyst 28 and the overheating may occur at the upstream-side catalyst 28 due to a reaction on the upstream-side catalyst 28. Therefore, the throttle downstream pressure control according to the present invention may be performed for the upstream-side catalyst 28.

Moreover, in the first and second embodiments, the throttle downstream pressure control that is performed during the stoichiometric air-fuel ratio operation has been described. However, a throttle downstream pressure control according to the present invention does not necessarily have to be performed during the stoichiometric air-fuel ratio operation, as far as, at the time of the occurrence of the blow-through air via an EGR channel, an air from the EGR channel and an unburned gas from a cylinder may join with each other and an unburned fuel of the unburned gas reacts with the air on an exhaust gas purification catalyst, and may also be performed at the time of any operation in which the air-fuel ratio is controlled to be richer or leaner than the stoichiometric air-fuel ratio. In addition, an internal combustion engine to which the throttle downstream pressure control according to the present invention is applied is not limited to a spark ignition type internal combustion engine that includes a three-way catalyst as an exhaust gas purification catalyst, as far as it is operated such that the overheating of the exhaust gas purification catalyst may occur due to the blow-through air. That is, an internal combustion engine to which the throttle downstream pressure control according to the present invention is applied may be a combustion ignition type internal combustion engine that includes any kind of exhaust gas purification catalyst (for example, oxidation catalyst) other than the three-way catalyst.

Further, in the second embodiment, an example in which the blow-through air ratio is used for calculation of the catalyst temperature increase amount ΔTuf has been described. However, where a temperature estimation for an exhaust gas purification catalyst is performed with taking into consideration the influence of the blow-through air, the blow-through air ratio itself does not necessarily have to be used, as far as estimation based on the flow rate of the blow-through air and the flow rate of the inflow air into an intake channel is performed. The catalyst temperature increase amount ΔTuf may therefore be calculated with reference to, for example, a map (not shown in the drawings) that defines a relationship between the flow rate of the blow-through air and the flow rate of the inflow air and the catalyst temperature increase amount ΔTuf.

Furthermore, in the first and second embodiments described above, a configuration in which the compressor 20a of the turbo-supercharger 20 is installed in the intake channel 12 is exemplified. However, a compressor configured to supercharge intake air according to the present invention is not limited to a compressor of this kind of turbo-supercharger, and may be, for example, an electrically driven compressor or a compressor of a mechanically driven type supercharger that uses, as its power force, the torque of a crankshaft of the internal combustion engine. In addition, if this kind of electrically driven compressor is used, the limiting of the throttle downstream pressure may be performed, for example, with adjustment of the opening degree of a throttle valve or adjustment of a compressor rotational speed by means of an electric motor. If a compressor of a mechanically driven type supercharger is used, the limiting of the throttle downstream pressure can be performed with, for example, adjustment of the opening degree of a throttle valve, as with the example in which the compressor of the turbo-supercharger is used.

What is claimed is:

1. A control apparatus for an internal combustion engine that includes:
a compressor arranged in an intake channel and configured to supercharge intake air;
a throttle valve arranged in a portion of the intake channel on a downstream side of the compressor and configured to open and close the intake channel;
an exhaust gas purification catalyst configured to purify exhaust gas that flows through an exhaust channel;
an EGR channel that connects a portion of the exhaust channel on an upstream side of the exhaust gas purification catalyst and a portion of the intake channel on a downstream side of the throttle valve; and
an EGR valve arranged in the EGR channel and configured to open and close the EGR channel,
the control apparatus comprising:
a blow-through air detecting section programmed to detect an occurrence of a blow-through air that flows from the intake channel to the exhaust channel via the EGR channel; and
an intake air pressure limiting section programmed to limit an throttle downstream pressure that is an intake air pressure at the portion of the intake channel on the downstream side of the throttle valve to reduce overheating of the exhaust gas purification catalyst where an occurrence of the blow-through air is detected.

2. The control apparatus according to claim 1, further comprising:
a blow-through air flow rate obtaining section programmed to obtain a flow rate of the blow-through air;
an inflow air flow rate obtaining section programmed to obtain a flow rate of inflow air to the intake channel; and
a catalyst temperature estimation section programmed to calculate, as a final temperature estimation value of the exhaust gas purification catalyst at a time of an occurrence of the blow-through air being detected, a sum of a base catalyst temperature estimation value based on an operating condition of the internal combustion engine and a catalyst temperature increase amount based on the flow rate of the blow-through air and the flow rate of the inflow air,
wherein, where an occurrence of the blow-through air is detected and the final temperature estimation value is higher than an overheat determination value, the intake air pressure limiting section limits the throttle downstream pressure such that the throttle downstream pressure becomes equal to or lower than a value corresponding to the overheat determination value.

3. The control apparatus according to claim 1, further comprising:
a blow-through air flow rate obtaining section programmed to obtain a flow rate of the blow-through air;
an inflow air flow rate obtaining section programmed to obtain a flow rate of inflow air to the intake channel; and
a catalyst temperature estimation section programmed to calculate, as a final temperature estimation value of the exhaust gas purification catalyst at a time of an occurrence of the blow-through air being detected, a sum of a base catalyst temperature estimation value based on an operating condition of the internal combustion engine and a catalyst temperature increase amount based on the flow rate of the blow-through air and the flow rate of the inflow air,
wherein, where an occurrence of the blow-through air is detected and the final temperature estimation value is equal to or lower than the overheat determination value, the intake air pressure limiting section forbids the throttle downstream pressure from being limited.

4. The control apparatus according to claim 1,
wherein, where an occurrence of the blow-through air is detected, the intake air pressure limiting section limits the throttle downstream pressure such that the throttle downstream pressure becomes equal to or lower than an exhaust pressure value, and
wherein the exhaust pressure value is a value of the exhaust pressure at the portion of the exhaust channel to which the EGR channel is connected, and is at an engine load where the exhaust pressure of the portion of the exhaust channel becomes equal to the throttle downstream pressure under a current engine speed.

5. The control apparatus according to claim 4,
wherein the exhaust pressure value becomes greater when the engine speed is higher.
